(19) United States
(12) Patent Application Publication
(10) Pub. No.: US 2023/0371729 A1
(43) Pub. Date: Nov. 23, 2023

(54) Reusable Delivery Container and Delivery System

(71) Applicant: Recyclabox Limited, London (GB)

(72) Inventors: Thomas Bradbury Williams, London (GB); James Michael Seear, London (GB)

(21) Appl. No.: 18/027,544

(22) PCT Filed: Sep. 22, 2021
(86) PCT No.: PCT/GB2021/052461

§ 371 Date: Mar. 21, 2023

(30) Foreign Application Priority Data
Sep. 22, 2020 (GB) 2014946.4

(51) Int. Cl. A47G 29/14

(52) U.S. Cl. CPC A47G 29/141; A47G 2029/143

(57) ABSTRACT

A reusable delivery container comprising an enclosure for containing an item; a closure selectively allowing access to the enclosure; a display on an outer surface of the container, comprising configurable electronic ink for displaying delivery information; an electronic lock for selectively securing the closure, the electronic lock having updatable unlock criteria; a 5 receiver configured to receive data communications, the data communications comprising at least lock data; power circuitry for providing power from a power source to the display, the electronic lock, and the receiver; and control circuitry arranged to control the electronic lock and update the unlock criteria, based on lock data received by the receiver.

### TECHNOLOGICAL BACKGROUND

Delivery of items conventionally takes place using delivery containers made of cardboard, plastic, or other disposable materials, with these materials being typically used only once. In order for the postal or courier services to know the intended destination for the items, information is typically printed, stamped, or hand-written onto the delivery containers or adhesive labels attached to the containers. These labels and containers are disposed after delivery, i.e. once they have served their purpose. Therefore, to reduce the environmental impact of this process, these containers and labels may be made from recyclable materials.

Furthermore, if secure delivery of items is desired, conventional postal or courier services cannot be trusted to ensure delivery containers are not opened and, therefore, it is typical to use end-to-end security companies for collection, transportation and delivery of valuable items. In essence, a locked box containing the items is escorted by a security professional from sender to recipient, being unlocked on delivery. Examples of these systems include so-called ‘cash-in-transit’ boxes and the like.

As such delivery containers are prevalent in everyday use, improvements in these delivery containers are both desired and required.

### SUMMARY

Viewed from first aspect there is provided a reusable delivery container comprising an enclosure for containing an item; a closure selectively allowing access to the enclosure; a display on an outer surface of the container, comprising configurable electronic ink for displaying delivery information; an electronic lock for selectively securing the closure, the electronic lock having updatable unlock criteria; a receiver configured to receive data communications, the data communications comprising at least lock data; power circuitry for providing power from a power source to the display, the electronic lock, and the receiver; and control circuitry arranged to control the electronic lock and update the unlock criteria, based on lock data received by the receiver.

By employing electronic ink in a label display, so as to create a so-called ‘e-label’, the label can be reused multiple times. The e-label can be updated with new delivery information before or during a delivery process and requires very little or even no power to maintain the displayed delivery information. In certain examples, the container is configurable to require no power during transport. This advantageously allows for any delivery or courier service to be able to securely transport the container.

Furthermore, the reusable delivery container is highly reusable by virtue of the closure selectively allowing access to the enclosure and the use of an e-label. Therefore, the amount of packaging waste in a delivery system using the container can be greatly reduced. As a further advantage, the energy intensive recycling process is not required.

Moreover, the use of an electronic lock having updatable unlock criteria greatly improves the security of a reusable delivery container. As is described in more detail below, the present invention may allow for only a recipient—not the sender or delivery service—to have knowledge of the unlock criteria to unlock the container. Therefore, the cost and difficulty of transporting valuable goods can be reduced.

According to an example, the receiver is further configured to receive delivery data, the control circuitry is arranged to control the display, and the control circuitry is further configured to update the displayed delivery information based on received delivery data.

By updating the delivery information using delivery data provided to the receiver of the container, the container can be transported from location to location, having the delivery information updated remotely or locally, without the need to transport the container back to a delivery depot (who may be in possession of the delivery data for the next recipient). Instead, the e-label can be updated to display the next recipient's delivery information by, for example, a user currently in possession of the container. Thus, the number of trips made by the container during its life can be reduced. In turn, this reduces the environmental impact of a delivery system employing such containers.

According to an example, the electronic lock is configured to adopt an unlocked state in response to the receiver receiving unlock data that satisfies the unlock criteria.

By unlocking the container using unlock data transmitted to the receiver, the privacy of unlock data entry can be enhanced. Therefore, the unlock criteria can remain as being known only to a given user, if desired.

According to an example, the reusable delivery container further comprises a location sensor, wherein the unlock criteria comprise at least one unlock location, and the control circuitry is configured to unlock the electronic lock upon a determination by the location sensor that the delivery container is within a predetermined radius of the at least one unlock location.

This further enhances the security and convenience of the container, as it is possible to automatically unlock the container upon arrival at an intended location. If the containers are integrated into a scaled operation involving many such containers, this greatly increases the delivery throughput of the operation.

According to an example, at least one of: the at least one unlock location; and, the predetermined radius of the at least one unlock location, are provided as lock data to the receiver.

In this option, both the GPS location but also the specificity of GPS radius can be changed per delivery. This may be advantageous for deliveries which include both countryside and inner city deliveries, where the distance between delivery destinations and nearest neighbours is changeable. The specificity of the GPS need not be so strict where buildings are spaced further apart, thereby reducing the need for high position location accuracy on specific deliveries.

According to an example, the control circuitry comprises data storage means with one or more lock data stored thereon, and the control circuitry is arranged to update the unlock criteria based on the one or more lock data stored on the data storage means.

The container, having lock data stored thereon (i.e. additionally to the current unlock criteria), can iterate or cycle between these different unlock criteria. Therefore, maintained contact with a wider network is not necessary and the container can be employed in more real-world settings, such as where connection with a network may be inconsistent. The flexibility of use of the container is therefore greatly increased.

According to an example, the control circuitry is arranged to update the unlock criteria in response to at least one of a detected change in a location of the delivery container, a detected change in a locked state of the electronic lock, and a detected receipt of lock data.

By updating unlock information when the container changes location, the security of the container (i.e. the security of the item within the container) can be improved. For example, a container containing a camera stored in a camera shop can be configured to lock and remain locked if the camera leaves the shop prematurely. However, using aspects of the present invention, the unlock criteria may of course be updated to change the authorised location for the container remotely, so as to unlock the container comprising the camera once it arrived at an authorised location. Such an authorised location may be, for example, a customer's address.

Furthermore, by triggering an update to unlock criteria and/or delivery information based on physical properties of the container, it is not necessary for the container to have constant contact with an external network in order to update its status. Therefore, a delivery system comprising such containers is more robust and adaptable, for example being able to deliver to more remote locations, which may have intermittent, poor or no network connectivity.

According to an example, the control circuitry is arranged to update the unlock criteria and the displayed delivery information in response to an update instruction received by the receiver.

Update instructions may be sent to the container via the receiver. This allows for a centralised management system where containers can have their unlock criteria and/or delivery information changed remotely. Therefore, the security of the items contained therein can be remotely managed so that, for example, only one user at a time has access. Such an arrangement also reduces the requirement for update instructions to be manually generated and/or stored in the device, making the device itself less complex.

According to an example, the control circuitry is further configured to update displayed delivery information in response to a confirmation that the electronic lock has adopted a locked state.

It is therefore advantageously possible to link the destination for a container to the ‘locking out’ of a previous owner. This further enhances the security of the system, as previous owners are unable to re-access the container, despite previously being able to.

According to an example, the control circuitry is further configured to update unlock criteria in response to a confirmation that the electronic lock has adopted a locked state.

As above, this configuration of the control circuitry provides greater safety and reliability for users of the reusable delivery container.

According to an example the item comprises an electronic device.

Electronic devices are often valuable and thus benefit especially from the secure nature of the described delivery container.

According to an example, the reusable delivery container further comprises device verification means, wherein the device verification means comprises at least one connection means for exchanging communications with the electronic device to confirm the presence of the electronic device in the enclosure.

By including device verification means, it can be ensured that the item desired for delivery is within the container to be sent to the recipient. This advantageously reduces the risk of fraud during transactions. Furthermore, this arrangement may reduce instances where there is a need for a subsequent (correct) delivery, which may otherwise contribute negatively to an environmental impact of a delivery service.

According to an example, the electronic lock is configured to adopt the locked state in response to confirmation of the presence of the electronic device in the enclosure.

This further contributes to the security of the container, whilst also conveniently ensuring that users are not accidentally locked out of the container during closing of the container when the item is not contained therein.

According to an example, the reusable delivery container further comprises a rechargeable power source.

As users may be expected to form part of a distributed delivery service, it may be more convenient and also provide reliability to the system if users are not expected to provide power to the container. Therefore, a rechargeable power source may sustain the container across a number of updates to display information and unlock criteria—i.e. across a number of stages along a delivery route—before requiring recharging.

According to an example, the delivery information comprises at least one barcode.

Delivery service providers typically employ barcodes and barcode scanners in their operations. Therefore, in order to integrate seamlessly within existing systems, it may be advantageous to co-ordinate with such delivery service providers in order to provide delivery information that is compatible with their scanners and other equipment and/or systems.

Viewed from another aspect there is provided a delivery system comprising a reusable delivery container such as those described above; and, a wireless communication network configured to exchange data communications with the delivery container.

The wireless communications network can act as a management system, co-ordinating deliveries and orders as the containers are transported from location to location. The wireless communications network can include means for storing and transmitting lock/unlock data and/or delivery data to containers. These updates may be in response to a request from users, a notification from containers themselves, a predetermined length of time, or some other event.

It is advantageous to remotely update the unlock criteria from the wireless communications network so as to provide an increased security and enhanced reusability for the reusable delivery containers. This also increases the safety as, by remotely generating unlock criteria, rather than locally, the container is less vulnerable to hacking.

In an example, the system comprises at least one user device for exchanging data communications with the delivery container, wherein at least one of the at least one user device is configured to generate lock data or relay lock data from the wireless communication network, to update the unlock criteria of the electronic lock.

Therefore, a user can use a device to update unlock criteria and/or delivery information for the delivery container, for example using an application downloaded onto the user device and communicating to the container using short-range wireless communications. This increases the ease of use of the container for the user while simultaneously enable greater control over the updates of the unlock criteria and/or delivery information for the owner.

In an example, at least one of the at least one user device is further configured to provide unlock data, via the receiver, to satisfy the unlock criteria of the electronic lock.

In this example, the user device can also be used to unlock the delivery container, therefore providing greater security through the use of more complex unlocking means such as an exchange of encryption keys. Furthermore, users are provided with a more convenient experience if they can use their device to unlock, as well as lock, the delivery container.

In an example, the system further comprises a timer for measuring time. According to this example, the control circuitry of the container controls the timer to measure a time between removal and replacement of an item from the container.

The inclusion of a timer can ensure that a user renting an item using the delivery system rents the item for their allotted rental period. If they exceed this time, the control circuitry can provide an update to the receiver (wherein the receiver may be a transceiver) to update the wireless communication network which can update rental conditions, such as charges, to the user accordingly.

Thus, a highly reliable and secure rental scheme can be provided, which requires minimal, or no, intervention from an owner of the item. This system also allows a reduced number of trips required by a delivery service, as there is no requirement for the item to go back to the owner before being transported to the next user who is renting the item. Furthermore, this system means the owner need not store the item, which requires storage space and can increase costs, rather the owner may arrange a continual rental of the device.

Viewed from another aspect there is provided a delivery method comprising providing first lock data to a reusable delivery container such as those described above; updating unlock criteria for an electronic lock of the delivery container based on the first lock data; providing delivery data to the delivery container, the delivery data corresponding to a first delivery location for the delivery container; updating a location of the delivery container to the first delivery location; providing second lock data to the delivery container, the second lock data being different to the first lock data; updating the unlock criteria based on the second lock data; updating the delivery data so as to display updated delivery information on the display of the delivery container, the delivery data corresponding to a second location; updating a location of the delivery container to the second delivery location.

As above, this provides a secure and environmentally friendly delivery method, with other advantages discussed below.

### BRIEF DESCRIPTION OF THE DRAWINGS

One or more embodiments of the invention will now be described, by way of example only, and with reference to the following figures in which:

FIG. 1A shows a schematic view of a reusable delivery container according to an example;

FIG. 1B shows a perspective view of a reusable delivery container according to an example;

FIG. 2A shows a schematic cross-sectional view of the reusable delivery container from FIG. 1, according to an example;

FIG. 2B shows the reusable delivery container of FIG. 2A with the closure opened to receive an item;

FIG. 3 schematically shows a delivery system according to an example;

FIG. 4 schematically shows an example application of the system from FIG. 3, according to an example; and,

FIG. 5 schematically shows another example application of the system from FIG. 3, according to an example of the invention.

While the invention is susceptible to various modifications and alternative forms, specific embodiments are shown by way of example in the drawings and are herein described in detail. It should be understood however that the drawings and detailed description attached hereto are not intended to limit the invention to the particular form disclosed but rather the intention is to cover all modifications, equivalents and alternatives falling within the spirit and scope of the claimed invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein

### DETAILED DESCRIPTION

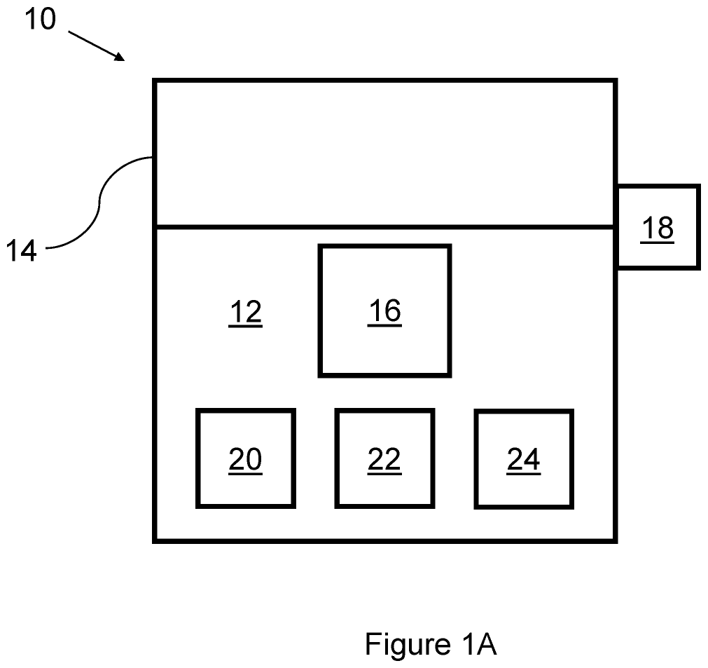

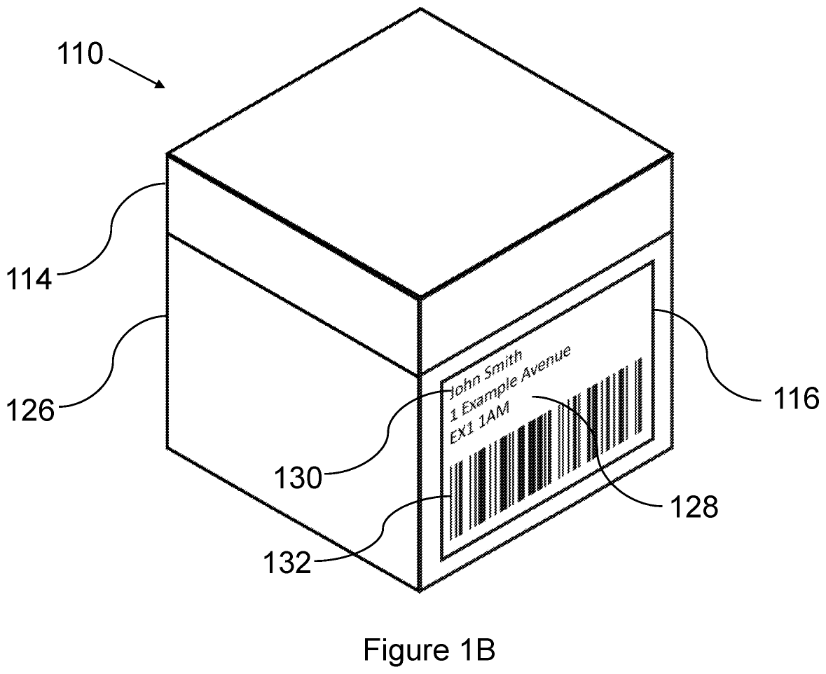

FIG. 1A shows a schematic view of a reusable delivery container according to an example of the present invention. In the illustrated example, there is shown a reusable delivery container 10 (also referred to as a delivery container or simply ‘container’) having an enclosure 12 for containing an item. The delivery container 10 also includes a closure 14 selectively allowing access to the enclosure 12. In the shown example, the container 10 is in a closed position. The reusable delivery container is also shown with a display 16 on an outer surface of the container 10, comprising configurable electronic ink for displaying delivery information (not shown).

The closure 14 may be an access door, a movable panel, or the link and may be attached to the container 10 when in an open position or may become detached from the container 10 when in an open position.

An electronic lock 18 for selectively securing the closure 14 is shown attached to the closure 14. The electronic lock 18 has updatable unlock criteria that, when satisfied, cause the electronic lock to adopt an unlocked state. The reusable delivery container 10 also comprises a receiver 20 configured to receive data communications and power circuitry 22 for providing power from a power source to the display 16, the electronic lock 18, and the receiver 20. The illustrated container 10 also comprises control circuitry 24 arranged to control the electronic lock 18 and, optionally, the display 16 and the receiver 20. Whilst the receiver 20, the power circuitry 22 and the control circuitry 24 are shown schematically as disconnected boxes in FIG. 1A, these may be connected through wired or wireless means using appropriate electronics.

The display 16 comprises configurable electronic ink for displaying delivery information. The term “electronic ink” is meant to encompass any display technology that requires no or very low power to maintain its display, for example microencapsulated electrophoretic display technology. Therefore, by using electronic ink, the overall power consumption of the container 10 can be greatly reduced.

The electronic lock 18 may be any mechanism suitable for securing the enclosure 12 by securing the closure 14 a closed position. The electronic lock 18 comprises unlock criteria that, when satisfied, cause the electronic lock 18 to adopt an unlocked state. The electronic lock 18 is electronic in the sense that it comprises electronics that, at least, allow for the maintenance and updating of unlock criteria. For example, the electronic lock 18 can be a padlock having means for entering a passcode, password or the like. In this specific example, the unlock criteria may be the entry of a correct passcode.

The electronic lock 18 may be unlocked by some physical or electronic master key in the case of unlock criteria being forgotten, corrupted, or otherwise lost. The person skilled in art will appreciate that various fail-safes can be introduced at the expense of system security, or fail-safes can be removed with an increased risk that an item can become irrecoverably locked inside the container 10.

The receiver 20 is configured to receive data communications. These may be wired or wireless data communications. For example, the receiver 20 can include a wired data input means such as a USB, micro-USB, Ethernet or other data port capable of transferring data.

Additionally or alternatively, the receiver 20 can be configured to receive short-range or long-range wireless data communications. For example, the receiver 20 can be configured to receive Bluetooth® communications, W-Fi® communications, Near-Field Communications (NFC), Long-Term Evolution (LTE®) communications or the like.

In some examples, the receiver 20 can also comprise a transmitter. That is, the receiver 20 may be a transceiver 20. In these examples, the receiver 20 may be configured to exchange data communications with another device, such as a user device, to confirm satisfaction of the unlock criteria, confirm update of the delivery information, or for other such purposes.

The control circuitry 24 is arranged to control the electronic lock 18 and, optionally, the display 16, and/or the receiver 20.

The display 16 includes configurable electronic ink and, therefore, the control circuitry 24 may be optionally arranged to configure and re-configure the electronic ink so as to display delivery information. Such control may not be necessary in example cases where the display 16 is detachable and updatable by some other means.

The control circuitry 24 may include data storage means for storing one or more instances of delivery information. For example, multiple pieces of delivery information, representing multiple destinations along a delivery route, can be concurrently stored in the data storage means of the control circuitry 24. Upon updates of the delivery information, the control circuitry 24 can fetch the next piece of queued delivery data and re-configure the electronic ink of the display 16 to display updated delivery information based on the fetched delivery data. The re-configuration of electronic ink, as described above, is not energy intensive and therefore this is an efficient method for updating delivery information.

Alternatively, the control circuitry 24 can be arranged to monitor receipts at the receiver 20 of update messages. Upon receiving an update message, the control circuitry 24 may generate or relay a control signal to the display 16 to update the delivery information from the received update message. By not requiring excessive data storage in the reusable delivery container 10, the cost of manufacture of the container 10 can be reduced.

Similarly, the control circuitry 24 can be arranged to control and/or monitor a locked state of the electronic lock 18, i.e. locked or unlocked. The data storage means of the control circuitry 24 can further contain the unlock criteria which are to be satisfied in order to unlock the electronic lock 18. Alternatively, the unlock criteria may be stored in a storage means of the electronic lock 18 itself. Upon an update of the unlock criteria, the control circuitry 24 is configured to generate or relay new unlock criteria based on received or stored lock data. The previous unlock criteria may be deleted or simply rotated to the back of a queue or list of lock data.

The lock data may be received in bulk, for example prior to the container 10 being transported to a first destination, and stored in a data storage means of the control circuitry 24. Additionally or alternatively, the lock data may be received one by one via the receiver 20 after or during transport of the container 10 to a first destination. Storing the lock data in bulk allows the container 10 to update during transit without requiring a connection to a wireless communications network, thereby providing a more robust system. Receiving the lock data one by one ensures the lock data cannot be obtained from an attack on the container 10 and thereby improves the safety of the container 10.

As with the delivery data, the control circuitry 24 may have access to multiple sets of lock data that are used to update the unlock criteria upon, for example, an unlock-lock cycle of the electronic lock 18 or a detection of arrival of the container 10 at a predetermined location. A satisfaction of unlock criteria can cause said unlock criteria to be expired and the control circuitry may iterate to the next stored lock data. In this way, the unlock criteria may be updated based on the lock data. Configuring the control circuitry 24 is this manner allows the container 10 to be opened a set number of times and have its security controlled throughout transport. Moreover, as mentioned above, by internally generating an update of the unlock criteria in this way, it is not necessary to rely on an external communication to the container 10 to cause an update instruction, which may be difficult in remote locations.

The term unlock criteria is used to refer to the set of one or more criteria that each need to be satisfied in order for the electronic lock 18 to unlock. The unlock criteria may be updated based on lock data. For example, lock data can comprise a passcode, an encryption key, and/or a designated unlock location at which the electronic lock 18 unlocks. A selection from this set can be included in the unlock criteria, such as a passcode and an unlock location, so that the electronic lock 18 only unlocks upon entry of the passcode if the container 10 is also within a radius of the unlock location. Use of several unlock criteria further enhances the security of the container 10.

A further example of unlock criteria is a barcode such as a two-dimensional barcode, ‘QR’ code or the like that is displayed on the display 16. In this example, a user can employ a user device to scan or image the barcode and thereby trigger a data exchange with a communications network to obtain unlock data to cause the electronic lock 18 of the container 10 to adopt the unlocked state. Alternatively, the barcode can be displayed on the user device for identification by scanning or imaging means provided in the container 10, the barcode may be sent to the user device by a communications network or the like.

Lock data may be stored in data storage means of the control circuitry. For example a number of potential unlock criteria, such as a set of possible passcodes or unlock locations, can be stored and iterated between. That is, each set of lock data corresponds to potential future unlock criteria.

Unlock data can then be provided to the container 10, for example via the receiver 20, in order to contribute to a satisfaction of unlock criteria. In some examples, unlock data is the same as lock data, e.g. the lock data represents a passcode and the unlock data is that same passcode. In other examples, the unlock data is different but complementary to the lock data, for example an asymmetric pair of encryption keys. Unlock data may additionally or alternatively be provided directly to the electronic lock 18 via some input means such as a keypad or touchscreen.

For example, a recipient of the container 10, provided with necessary unlock data, can unlock the electronic lock 18 to access the contents of the enclosure 12. Then, upon said unlocking or upon a subsequent closing of the closure 14 and locking of the electronic lock 18, the unlock criteria are updated. The recipient, then becoming a sender, cannot use the same unlock data previously provided to them because the unlock criteria for the container have been updated to new unlock criteria, that do not correspond to the previous unlock data. Therefore, the security of the container 10 is maintained throughout the receiving, opening, closing, and sending process.

Alternatively, each update of the unlock criteria can be triggered by receipt of lock data and/or delivery data at the receiver 20. Alternatively, an update instruction that does not comprise lock data can trigger an update to unlock criteria based on stored lock data. For example, an external, potentially remote communications network (discussed in more detail below) can communicate an update instruction to the container 10 that causes the control circuitry 24 to iterate to the next set of stored lock data (previously received by the container).

Alternatively, lock data and/or delivery information can be provided as part of the update instruction communicated to the container 10 and the unlock criteria can be updated based on the newly received lock data. This approach advantageously removes a requirement for the control circuitry 24 to store lock data.

In one example, the reusable delivery container 10 can contain a location sensor and the lock data can represent an intended delivery location. As the container 10 is programmed with new delivery information, specifying a delivery address, or otherwise, corresponding lock data can be provided or generated from the delivery information. Then, when the location sensor detects that the delivery container 10 is within a predetermined radius of the intended delivery location (for example 20 metres, 50 metres, 100 metres or more or less based on the specific circumstances), the unlock criteria, updated based on the lock data corresponding to the location, will be satisfied and the electronic lock 18 will unlock. That is, the unlock data comprises a signal indicating that the location sensor has arrived within a radius of an unlock location. Larger radii may be of use in less built up areas, whereas closer radii may be more appropriate in built up areas.

Notably, this is one of a number of examples where the recipient is not explicitly involved in the unlocking of the container 10. Therefore, this may be advantageously applied to circumstances in which the recipient is not a known person but instead, for example, a business or a delivery depot which handle many packages at a time and so do not have the capacity or ability to unlock all of the containers but still desire a low-cost and secure delivery means. Use of such an opening container upon delivery to a location removes the requirement for specific container openers or opening systems.

The power circuitry 22 is configured to provide power to the electronic components of the reusable delivery container 10. For example, the power circuitry 22 can include a power input portion for connection to a power mains, a battery, a capacitor, or other power source. The power input portion can comprise an electrical port for insertion of a power cable.

Alternatively, the power input portion can comprise electrical contacts externally located and configured to abut a complementary set of powered electrical contacts so as to communicate power through the power input portion and into the power circuitry toward the electrical components. With this approach the container 10 can be conveniently powered by placement into appropriately configured racks, having such electrical contacts installed therein.

In some examples, the power circuitry 22 can include a power storage module such as a battery, a capacitor, or the like. In these examples, the power storage module can be rechargeable and the power input portion can be used to charge the power storage module with enough power to sustain the electronic components throughout the length of an expected use of the reusable delivery container.

The power circuitry 22 can be provided with solar panels, gyroscopic or kinetic charging, or other charging means that do not require a direct electrical power source to charge.

Furthermore, the power input portion can comprise a wireless charging means, such as inductive charging (for example a Qi® interface), that can draw power from an electromagnetic input. This would advantageously increase the resilience of the container 10 by removing an exposed electrical port from the outside of the container 10.

It is not necessary for all examples of the present invention to include a power storage module because, as discussed above, an electronic ink screen does not require a large amount of power to maintain displayed information. By not including a power storage module, the weight and cost of the reusable delivery container 10 can be further reduced.

In some examples, the container 10 can draw power through inductive charging means when in the range of an appropriately configured user device. In these examples, a user can position their device within range of the inductive charging means of the container 10 and thereby power the container 10. The control circuitry 24 may then update the unlock criteria of the electronic lock 18 and/or the displayed delivery information of the display 16. In some examples, the device may simultaneously exchange data communications with the receiver 20, such as lock data and/or delivery data. Although the aforementioned inductive charging means may struggle with high power scenarios, the display 16 advantageously employs low-power electronic ink. Thus, only a small amount of power is required to reconfigure the display 16, making the above described inductive charging means particularly convenient.

FIG. 1B shows a perspective view of a reusable delivery container 110 according to an example of the present invention. The reusable delivery container comprises a main body 126, in the specific example shown a cuboidal box that encloses an enclosure (not shown). The main body 126 is sealed by a closure 114; in the specific example shown, the closure 114 is a lid for the cuboidal box.

As shown in FIG. 1B, the reusable delivery container 110 has a display 116 attached to an outer surface of the container 110, facing outwards, with delivery information 128 displayed thereon. The display 116 is the same or similar to the display 16 shown in FIG. 1A. Whilst the display 116 is shown as being positioned on a portion of the outer surface of the main body of the container 110 in FIG. 1B, other arrangements are possible. For example, it is also possible for the display 116 to be positioned on the outer surface of the closure 114 or any position that would be convenient for integration into a delivery service.

In the illustrated example, the delivery information 128 comprises an address 130 and a one-dimensional barcode 132 but any form of delivery information may be displayed. For example, a two-dimensional barcode, such as a ‘QR’ code, or any representation of information that is able to communicate to a postal service, courier, or other delivery service the intended destination for the container. It is common for delivery service providers to employ barcode scanners in their package processing so it may be preferable for the display 116 to have appropriately configured display settings (contrast, brightness and the like) for ease of reading by a barcode scanner (or other computer vision).

In the illustrated example, the delivery information 128 is displayed using configurable electronic ink. As discussed above, by employing electronic ink, the power usage of the reusable delivery container 110 can be greatly reduced.

Whilst not shown, the container 110 in FIG. 1B also includes an electronic lock such as electronic lock 18 from FIG. 1A, a receiver such as the receiver 20 from FIG. 1A, power circuitry such as the power circuitry 22 from FIG. 1A and control circuitry such as the control circuitry 24 from FIG. 1A.

The walls that constitute the main body 126 of the container 110, as well as the closure 114, may be made of any material that would be suitable for secure storage without excessive cost or weight. The person skilled in the art would appreciate a balance between thickness and density of a material providing security but also increasing weight and cost to manufacture and transport the container 110. For example, the main body 126 and/or closure 114 can be made of injection-moulded plastic to reduce the weight of the container 110 whilst still providing suitable security and protection for the item. However, this might be more easily breached and thus less suitable for higher value items. Similarly, the main body 126 and/or closure 114 can be made out of sheet metals such as aluminium or steel, assembled with rivets, welding, or other means. This provides an increased security and protection for the item but would weigh more and therefore may cost more for delivery services to deliver the container 110.

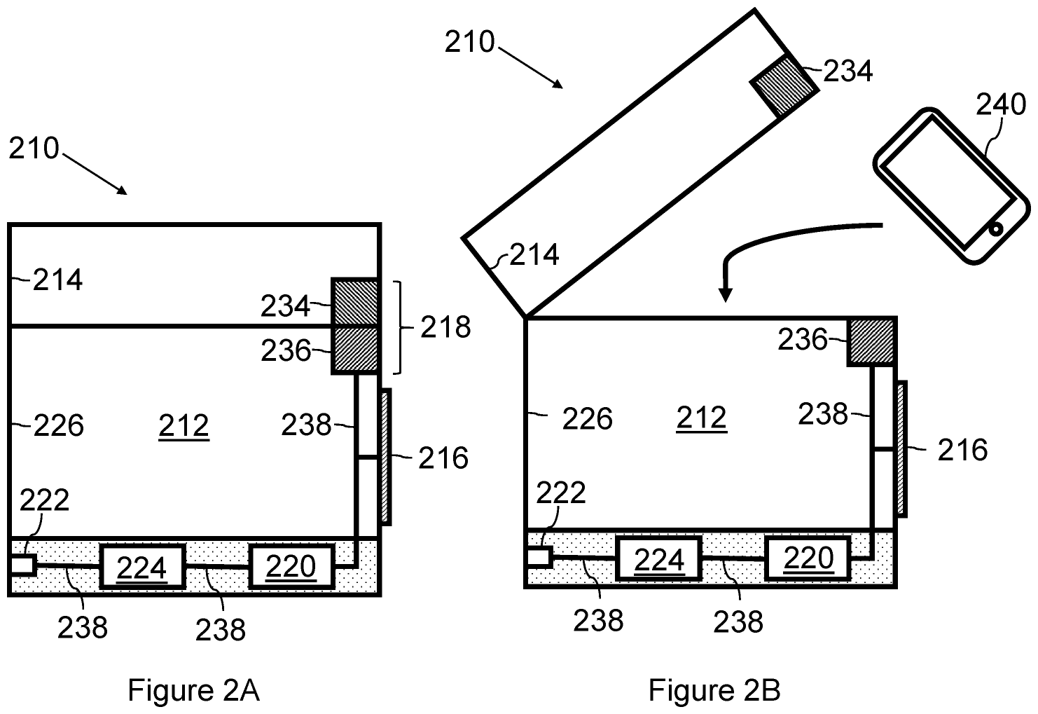

FIG. 2A shows a schematic cross-section of the reusable delivery container 110 from FIG. 1B. The delivery container 210 comprises an enclosure 212, a display 216, an electronic lock 218, a receiver 220, power circuitry 222, and control circuitry 224.

Whilst the display 216 is shown extending from the surface profile of the container 210, it is also possible to recess the display 216 into the side of the container 210 so as to achieve a seamless surface profile, which is less prone to damage during transport. To this effect, the display 216 can also be covered with a protective screen that is at least partially transparent so as to protect the display 216 whilst still allowing delivery information (not shown) displayed thereon to be read by a human or computer vision. For example, the display 216 may be protected by a sheet of resilient plastic or a metal wire mesh. This may also allow for greater weather resistance.

The electronic lock 218 is configured to secure the closure 214 of the reusable delivery container 210. In the illustrated example, the electronic lock 218 comprises locking members 234 and 236 that are configured to engage so as to secure the closure 214 in a closed position. The electronic lock 218 may have its locking state controlled electronically.

For example, the locking member 234 may include a projection and the locking member 236 may include a recess for receiving and retaining the projection in position until receipt of an electronic signal causes the locking member 236 to release the projection. In an example, the projection may be a buckle or the like. Additionally or alternatively, the locking members 234 and 236 can include an electronically controllable magnetic lock.

Whilst the electronic lock 218 is shown contained and concealed within the volume of the container 210, the electronic lock 218 may alternatively be installed on an external surface of the reusable delivery container 210 in a manner that facilitates the locking of the closure 214 in a closed position until satisfaction of unlock criteria.

In the specific example shown in FIG. 2A, the display 216, electronic lock 218, receiver 220, power circuitry 222, and control circuitry 224 (collectively ‘electronic components 216, 218, 220, 222, 224’) are connected by connective circuitry 238. In some examples, the reusable delivery container 210 comprises one or more sections for the placement of connective circuitry 238 and other electronic components 216, 218, 220, 222, 224. In the illustrated delivery container 210 of FIG. 2A, there is a section at the base of the container 210 in which electronic components 216, 218, 220, 222, 224 are placed. In another arrangement, these electronic components 216, 218, 220, 222, 224 may be mounted on an interior wall of the enclosure 212, embedded within the side walls of the container 210, or elsewhere such that the components 216, 218, 220, 222, 224 are protected from damage during use. As will be readily appreciated, it would be beneficial to install components 216, 218, 220, 222, 224 and circuity 238 in a manner that allows for easy maintenance or repair. Therefore, although not illustrated, the delivery container 210 may have one or more removable panels or access points for accessing the electronic components 216, 218, 220, 222, 224.

In the illustrated example of FIG. 2A, the power circuitry 222 is proximal to an external surface of the main body 226 of the container 210 so that it can be easily connected to an external power source.

The enclosure 212 is illustrated simply in FIG. 2A as the inside of a container 210, enclosed by main body 226 and the closure 214, i.e. the lid of the container 210. The enclosure 212 may further comprise stabilising components configured to stabilise items placed into the enclosure 212 during transport. For example, one or more biasing members, such as springs, may extend from the internal walls of the enclosure 212 so as to push the item against internal walls or opposing biasing members, thus holding the item in place during transfer.

Alternatively or additionally, the enclosure 212 may comprise an insert that is conformed to the shape of the item, for example a foam insert having a cut out that complements the shape of the item to be received or a memory foam insert that conforms to the shape of the item when the item is pressed against the surface of the memory foam.

The interior walls of the enclosure 212 can be padded with a resilient material such as rubber or foam so that impact of the item against the interior walls of the enclosure 212 during transport does not damage the item.

FIG. 2B shows the reusable delivery container 210 from FIG. 2A with the closure 214 opened to receive an item 240, in this case a mobile phone.

Whilst only one item 240 is shown, it is possible that the container 210 could be configured to receive and contain multiple items like item 240 or different to item 240. For example, the multiple items 240 can be stored in respective compartments or shelves of the container 210. Whilst electronic devices are referred to throughout by way of example, the reusable delivery container 210 can be used for any item or items of value. Indeed, the container 210 can be used to transport money, cash or the like which are to be considered as items of value.

In an example use case, the electronic lock 218 can be unlocked by satisfaction of the unlock criteria so that the closure 214 opens. In some examples, the closure 214 is biased toward an opening position, by one or more springs, opposing magnets or other biasing means, so that an unlocking of the electronic lock 218 leads to a sufficient opening of the closure 214 to prevent re-engagement of the locking members 234 and 236 of the electronic lock 218. This way, a user will have to apply force to re-engage the locking members 234 and 236. In cases such as those where unlock criteria may update in response to a locking of the electronic lock 218, this can prevent an accidental locking out of the user from the container 210.

The illustrated example shows a hinged container opening about a hinged attachment between the closure 214 and the main body 226 of the container. However, the closure 214 may be slidably, rotatably, magnetically or otherwise attached to main body 226 and may comprise an entire wall of the container 210 or only a portion of a wall. For example, the closure 214 can comprise a letterbox-shaped slot in a wall of the container 210 that is closed by sliding a plate thereacross. Alternatively, the closure 214 can comprise a zippered side of the container 210. It is possible to tailor the arrangement of the closure 214 and how it is opened or closed to the particular circumstances at hand.

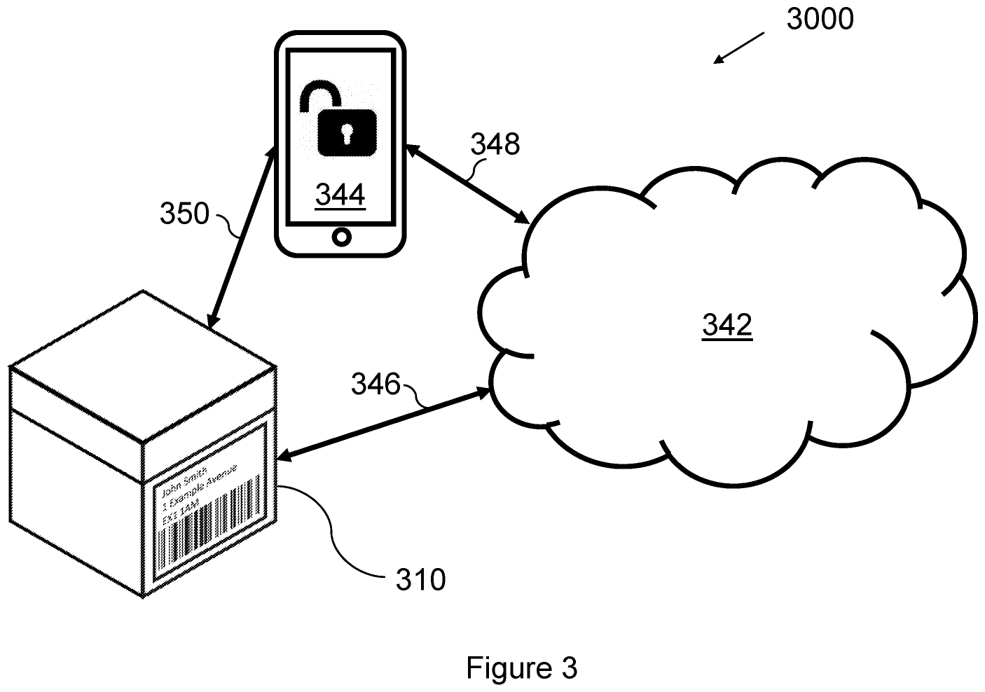

FIG. 3 shows a delivery system according to a further example of the present invention. Where similar (or the same) features are shown in FIG. 3 as to those features in FIGS. 2A and 2B, the numerals have been increased by 100. Where the function of these is the same, these may or may not be described herein for improved readability.

According to one example, the delivery system 3000 comprises a reusable delivery container 310, a wireless communications network 342 and, optionally, a user device 344.

The reusable delivery container 310 and the wireless communications network 342 are configured to communicate with each other via wireless communication protocols, such as those discussed in the forgoing or other wireless communication means. These communications are indicated graphically in FIG. 3 as line 346.

The wireless communication network 342 can exchange data communications with a user device 344, as indicted by line 348. The user device 344 can be a mobile phone, a tablet, a personal computer, a smart device, or any such device that is capable of wirelessly exchanging data communications. In some examples, the user device 344 has an application downloaded thereon that facilitates communications between the user device 344 and the wireless communications network 342. For example, the wireless communications network 342 may be managed by a delivery co-ordinator who provides an application for management and tracking of deliveries and/or unlocking of the container 310.

The user device 344 may be further configured to exchange communications with the delivery container 310, indicated by the line 350. For example, the user device 344 may be configured to generate complementary unlock criteria and/or receive complementary unlock criteria, complementary to the unlock criteria of the electronic lock, from the wireless communications network 342 and provide it to the receiver of the delivery container 310 via NFC or other communications technology so as to unlock the container 310. For example, the user device 344 can provide a complementary part of an encryption key to the container 310 which the control circuitry of the container may verify to establish that unlock criteria have been satisfied.

In some examples, an update to the unlock criteria will be triggered by an update instruction and the wireless communications network 342 will communicate lock data to the receiver (via a user device or directly) and communicate complementary unlock data to a user device 344 of the recipient so that the recipient can unlock the container 310 with the updated unlock criteria.

In a particular example, the wireless communications network 342 can provide a passcode to the electronic container 310, which updates the unlock criteria for the electronic lock. The wireless communications network 342 also communicates this passcode to the user device 344 so that a user, e.g. a recipient of the container, can enter the passcode into some entry means of the electronic lock to unlock the container 310.

Once the lock data has been communicated to the receiver, the control circuitry may be configured to update unlock criteria of the electronic lock based on lock data. For example, the lock data can be a password, a private key, or similar, which is provided to the recipient in advance of or in parallel with the delivery of the container 310 to the recipient.

In some examples, for example in the case of a password, the same data is communicated to the reusable delivery container and the recipient. That is, the container 310 may have its password updated to correspond to the new password from the lock data such that the recipient, being also provided with this updated password, can unlock the delivery container 310 upon receipt.

In an example, the unlock criteria are updated at each stage of delivery from a sender to a recipient, so that, upon sending the container 310, the sender becomes ‘locked out’ of the container 310 and only those in possession of the updated unlock information can open the container 310. Advantageously, this means that the delivery service handlers that transport the container to the recipient do not have access to the contents therein, thus improving the security of the delivery system.

Whilst in the above discussion, an updated password has been referred to, it is noted that there are many ways in which the container 310 can be locked, unlocked, and have its unlock criteria changed whilst still falling within the scope of the claims.

In another example, the lock data comprises one half of an asymmetric pair of encryption keys while the other half is provided to a user in the form of unlock data. The lock data can be provided to the delivery container 310 directly via long-range wireless communications from the wireless communications network 342 or via a user input device 344 belonging to a sender, for example as part of the locking process for the container 310.

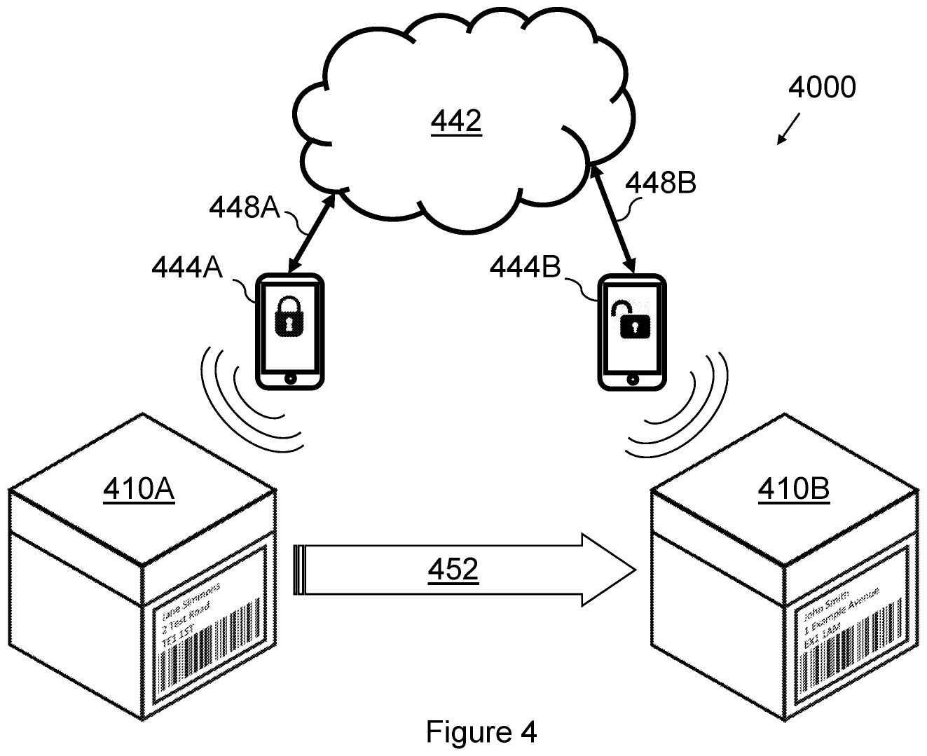

FIG. 4 shows a schematic view of an example application of the delivery system of FIG. 3. In the specific example shown, a reusable delivery container 410A, 410B is shown in two states, before 410A (left) and after 410B (right) an update of the unlock criteria and delivery information. The arrow 452 from left to right between the delivery containers 410A, 410B is intended to indicate a passage of time, for example from a time at which the sender closes and locks the container 410A to a time at which the container 410B has been delivered by a delivery service to the recipient and the recipient unlocks and opens the container 410B.

A sender, in possession of the container 410A having their delivery information displayed on a display, can put an item into the container 410A. At this point, it is possible to employ device verification means to verify that the item is present in the container 410A, for enhanced security. This may be for example a USB adapter or lightning adapter or the like which may communicate with and verify the item. Alternatively, the container 410 can contain imaging means for imaging the items placed within it. As an example, the images of the items can be processed with a machine learning algorithm to confirm their presence in the container 410 and/or identify any wear and tear on the item incurred during the user's use of the item.

In some examples, a user may provide information about the condition of an item manually and this can be relayed, for example by the display on the container 410, to verification staff. In such a way, verification of a submitted quality of a deposited item can occur via either or both of machine learning and human verification. These features provide a robust defence against fraudulent submissions of the quality of deposited items. This also allows the system to record the quality of an item at a given point in the process and therefore, if damage occurs to the item subsequently in the process, the system may more accurately locate when the damage occurred.

Once the item is in the container 410A, the sender can lock the container 410 using their device 444A. In an example, without this verification the container 410 cannot be locked.

The wireless communications network 442 communicates lock data, such as half of an encryption pair, to the user device 444A via the communication channel 448A. The lock data is received via NFC at the receiver of the container 410A. Either in response to the receipt of the lock data, or in response to an internally or externally generated update instruction (for example in response to a closing of the lock or a selection in an application on the user device 444A), the control circuitry of the container 410A can then update the unlock criteria of the electronic lock based on the lock data. The container 410A may simultaneously or subsequently update the displayed delivery information based on stored or received delivery data so that the displayed delivery information corresponds to that of an intended recipient. The sender can then themselves, or using a delivery service, transport the delivery container 410A to the intended (second) recipient shown in the updated delivery information.

The second recipient can then be sent, or request to be sent, to their user device 444B, unlock data for satisfying the updated unlock criteria from the wireless communications network 442, via communications channel 448B. In some examples, the second recipient may be required to overcome security checks in order to be provided with the unlock data. Once the user device 444B is provided with the unlock data for the container 410B, the second recipient can use their user device 444B to unlock the container 410B. Again, as an example, NFC technology can be used to exchange data communications such as encryption keys in order to verify the identity of the recipient's device 444B.

By providing the sender's device 444A with one set of unlock criteria and providing the recipient's device 444B with a complementary of unlock criteria, only one device at any one time has permission to open the container 410. This means that delivery services will not have access to the container 410 in transit and previous recipients are effectively locked out of the container 410. This security is further enhanced if the unlock criteria are updated after a closing of the container 410 or arrival/departure of the container 410 at/from a location. For example, the container 410 can be configured to automatically update unlock criteria when it leaves the premises of a sender, location data for the sender's premises being previously communicated to the container 410.

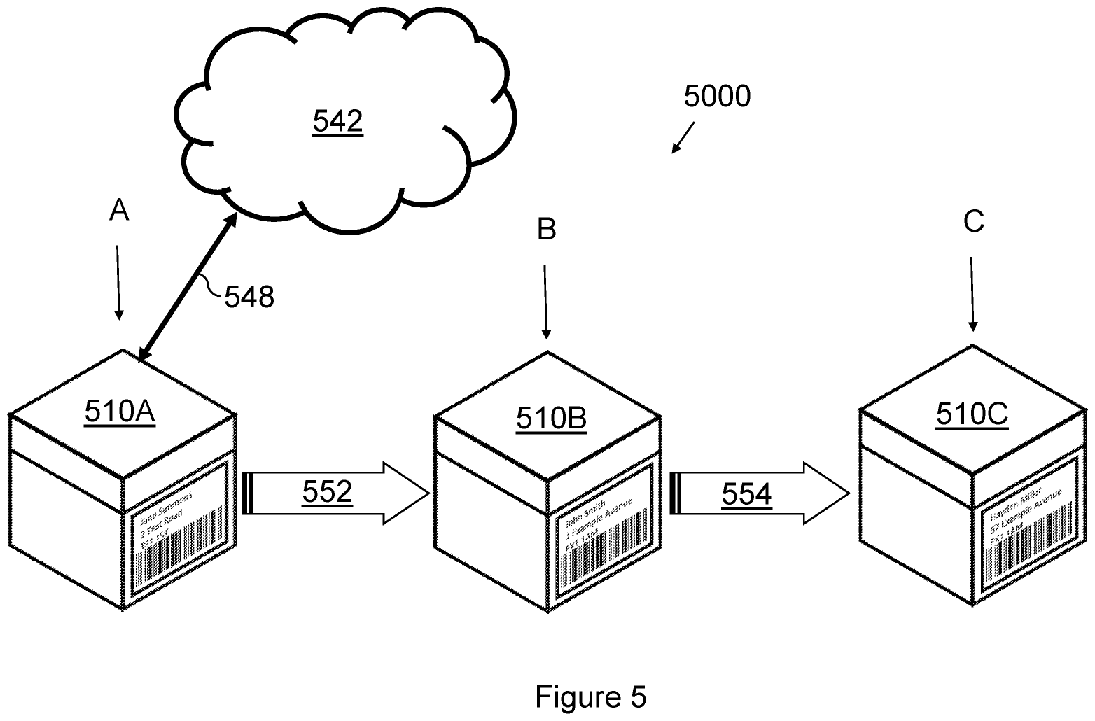

FIG. 5 shows another example application of the delivery system of FIG. 3. A reusable delivery container 510 is shown in three states 510A, 510B, 510C along the course of a delivery or rental scheme. Container 510A represents a container 510 before being shipped to a first location represented by arrow B. Container 510B represents the container 510A having been transported to location B, the transportation being represented by arrow 552. Similarly, container 510C represents the container 510B having been transported to location C, the transportation being represented by arrow 554.

In the illustrated example of FIG. 5, only container 510A at the origin, generally indicated by the arrow A, is in communication with the wireless communications network 542, as indicated by arrow 548.

As part of the example application, the container 510A, in communication with the wireless communications network 542, is provided with multiple sets of lock data, one of which is initially chosen to configure the unlock criteria of the electronic container 510A. The container 510A is also provided with multiple sets of delivery data, representing multiple stops on a delivery route. In the example shown, the multiple stops are to location B and location C. One of the set of delivery data, corresponding to location B, can be applied by the control circuitry to the display so that the display configures the electronic ink to display delivery information.

After a recipient at location A has unlocked the container 510A, used the item and replaced the item, the container 510A can then be closed, locked with the unlock criteria set by the lock data, and securely transported to location B. The delivery service can read or scan the delivery information to establish where to deliver the container 510A, i.e. location B.

A recipient at location B can be provided in advance with the unlock criteria that will unlock the container 510B at location B. For example, the wireless communication can send a passcode or password to the user when initially configuring the container 510 at location A, or during transport of the container 510A from location A to location B. As another example, the lock data can comprise an unlock location, e.g. location B, and, optionally, a predetermined radius. In this example, the container 510 will be provided with a location sensor. When the container arrives within a predetermined radius of location B, the unlock criteria will be satisfied and the container 510 will become unlocked. The predetermined radius can be limited so as to distinguish between individual apartments or very large to account for an entire delivery depot. The cost and/or weight of the location sensor will vary based on the desired precision. A suitable selection may be made based on the intended use of the container.

The recipient at location B may have paid for a limited time to be in possession of the container 510B. In this case, the container 510 may be equipped with a timer configured to measure a time between removal and replacement of an item from the reusable delivery container 510. Alternatively, the timer may measure the amount of time the container 510 has been at location B. The user may be presented with a countdown on the container or on a complementary application on their user device and the user may be charged more if the item is not replaced in time and/or if the container does not leave location B or arrive at location C by a given time.

When the user at location B wishes to transport the container 510B to the location C, the container 510B may be configured to trigger an update instruction after a predetermined time, upon closing/locking of the container 510B, upon pressing of a button on the container 510B, or by other means. The update instruction will cause the control circuitry to update the unlock criteria of the container 510B from the stored set of lock data and the control circuitry will update the display with the stored delivery data to display updated delivery information corresponding to location C. The container 510B can then be transported to location C by any delivery means.

When the container 510C arrives at location C, a user can similarly unlock the container 510C using their unlock criteria, which may be known only to them and provided to them by the wireless communications network 542.

The timing capability of the container 510 is only one example of a possibly broader computing capability of the container 510. The control circuitry of the container 510 can, for example, store information about a user and the user's transaction. As another example, the container 510 may also contain an accelerometer that collects information on the treatment of the container 510, for example if the container 510 has been dropped, if the casing of the container 510 is breached, etc. The control circuitry may be configured to display associated information from the accelerometer on the display of the container, or send a message to a user and/or communications network, for example, a warning that the container 510 may be damaged or items from the container 510 may be compromised.

This locking and unlocking process can continue for any number of locations. In the case where an update is triggered by a lock-unlock change or by opening, closing of the container 510 or other physical indicators, the container 510 may not require a power module therein and the users can power the container 510 at locations A, B and C when updating of the electronic ink display and updating of the unlock criteria is desired. Users can power the container by using a power lead, for example provided to them in advance, wireless power, or by placement into a sunny location if the container 510 is provided with solar panels. Alternatively, as discussed above, the user may provide power to the container 510 via their user device.

It will be appreciated that the container 510 may have contact with the wireless communications network sporadically at either of locations B or C or during transfers 552 or 554, at which point further lock data and/or delivery data can be provided to the container 510 via the receiver.

In some examples, if no further delivery data is available, the display may default to displaying default delivery information, corresponding to the origin location A, a desired collection depot, or other location. Advantageously, this causes containers 510 to be controllable through the delivery system 5000 to ensure arrival back at a desired location.

By not requiring constant power and/or constant wireless signal, the container 510 can be adapted to suit instances where locations are remote or otherwise power- or signal-poor.

The system 4000 of FIG. 4 can adopt at least some of the functionality of the system 5000 of FIG. 5 and vice versa. In an example, the container 510 may connect to the communications network 542 as and when a network connection becomes available.

Whilst FIG. 4 and FIG. 5 both show a single container 510 and discuss a single item contained therein, it can be advantageous to deploy the above described systems 4000 and 5000 with multiple containers similar, or identical, to the container 510, each containing one or more items.

In such systems, the communications network 542 can be arranged to optimise delivery networks. For example, after receiving an item from a container, the user can return the container 510 back into the delivery network, for example by returning to a post office or courier office, or by arranging collection from their location. The co-ordinating communications network 542 can then identify a user that is reaching the end of a rental term for an item, for example, and arrange for the container 510 to be delivered to said user for use in transporting that item to a subsequent user.

This network may be scaled so that users can receive or deposit items as part of a rental scheme, collect items they have purchased, or send items they have sold using the same container 510, multiple containers 510, or multiple compartments or shelves of the same container 510, wherein each compartment or shelf may have different unlock criteria.

The co-ordinating communications network 542 may collect information about ongoing transactions, apply a best-path algorithm, and select an optimised path between users. Such best-path algorithms may include the ‘Chinese Postman’ algorithm, Dijkstra's algorithm, or a ‘branch and bound’ algorithm. A particular advantage provided by the use of a branch and bound algorithm is that it is less computationally intensive when the size of a network becomes large. The communications network 542 may then enact this best path by providing delivery data to the container and/or users, for example via user devices. Such an algorithm integrates the journeys of a plurality of containers into the calculations for optimised paths between users such that a user may receive an item from one container and deposit it into another for return (under the rental scheme).

By co-ordinating such a ‘peer-to-peer’ delivery network, as opposed to a ‘top-down’ whereby a central delivery warehouse physically processes delivery containers, the distance travelled by the containers in the course of a delivery path can be greatly reduced. Indeed, in such a ‘peer-to-peer’ delivery network, there is no need to return to a depot between users. In such a way, the total number of required delivery journeys for N users can be reduced from 2N (user1−depot−user2−depot etc) to N+1 (user1−user2−user3− . . . −depot). Therefore, emissions for the delivery network as a whole can be greatly reduced. Furthermore, by increasing the ease with which users can sell or rent their items, users can be discouraged from disposing of their items and/or purchasing new items (as opposed to pre-owned). This further reduces the environmental impact of waste plants, for example by reducing electronics waste.

Furthermore, such delivery networks may also employ item deposition stations, whereby a user can deposit or collect containers and/or items from item deposition stations instead of from their homes, post offices, or courier offices. Such item deposition stations can be situated in convenient locations such as supermarkets, town halls or the like.

The item deposition stations can be communicatively coupled to a communications network such as communications network 542 and configured to exchange data communications with containers 510, for example to update their displayed delivery information or unlock criteria.

As such, there is described herein a reusable delivery container comprising: an enclosure for containing an item; a closure selectively allowing access to the enclosure; a display on an outer surface of the container, comprising configurable electronic ink for displaying delivery information; an electronic lock for selectively securing the closure, the electronic lock having updatable unlock criteria; a receiver configured to receive data communications, the data communications comprising at least lock data; power circuitry for providing power from a power source to the display, the electronic lock, and the receiver; and control circuitry arranged to control the electronic lock and update the unlock criteria, based on lock data received by the receiver.

1. A reusable delivery container comprising:
an enclosure for containing an item;
a closure selectively allowing access to the enclosure;
a display on an outer surface of the delivery container, comprising configurable electronic ink for displaying delivery information;
an electronic lock for selectively securing the closure, the electronic lock having updatable unlock criteria;
a receiver configured to receive data communications, the data communications comprising at least lock data;
power circuitry for providing power from a power source to the display, the electronic lock, and the receiver; and
control circuitry arranged to control the electronic lock and update the unlock criteria, based on lock data received by the receiver.

2. The reusable delivery container of claim 1, wherein:
the receiver is further configured to receive delivery data,
the control circuitry is arranged to control the display, and
the control circuitry is further configured to update the displayed delivery information based on received delivery data.

3. The reusable delivery container of claim 1, wherein the electronic lock is configured to adopt an unlocked state in response to the receiver receiving unlock data that satisfies the unlock criteria.

4. The reusable delivery container of claim 1, further comprising a location sensor, wherein:
the unlock criteria comprise at least one unlock location, and
the control circuitry is configured to unlock the electronic lock upon a determination by the location sensor that the delivery container is within a predetermined radius of the at least one unlock location.

5. The reusable delivery container of claim 4, wherein at least one of:
the at least one unlock location; and,
the predetermined radius of the at least one unlock location,
are provided as lock data to the receiver.

6. The reusable delivery container of claim 1, wherein:
the control circuitry comprises data storage means with one or more lock data stored thereon, and
the control circuitry is arranged to update the unlock criteria based on the one or more lock data stored on the data storage means.

7. The reusable delivery container of claim 6, wherein the control circuitry is arranged to update the unlock criteria in response to at least one of:
a detected change in a location of the delivery container,
a detected change in a locked state of the electronic lock, and
a detected receipt of lock data.

8. The reusable delivery container of claim 2, wherein the control circuitry is arranged to update the unlock criteria and the displayed delivery information in response to an update instruction received by the receiver.

9. The reusable delivery container of claim 2, wherein the control circuitry is further configured to update displayed delivery information in response to a confirmation that the electronic lock has adopted a locked state.

10. The reusable delivery container of claim 1, wherein:
the control circuitry is further configured to update unlock criteria in response to a confirmation that the electronic lock has adopted a locked state.

11. The reusable delivery container of claim 1, wherein the item comprises an electronic device.

12. The reusable delivery container of claim 11, further comprising device verification means, wherein the device verification means comprises:
at least one connection means for exchanging communications with the electronic device to confirm a presence of the electronic device in the enclosure.

13. The reusable delivery container of claim 12, wherein the electronic lock is configured to adopt a locked state in response to confirmation of the presence of the electronic device in the enclosure.

14. The reusable delivery container of claim 1, further comprising a power source, wherein the power source is rechargeable.

15. The reusable delivery container of claim 1, wherein the delivery information comprises at least one barcode.

16. A delivery system comprising:
the reusable delivery container according to claim 1; and
a wireless communication network configured to exchange data communications with the delivery container.

17. The delivery system of claim 16 further comprising:
at least one user device for exchanging data communications with the delivery container, wherein:
at least one of the at least one user device is configured to generate lock data or relay lock data from the wireless communication network, to update the unlock criteria of the electronic lock.

18. The delivery system of claim 17, wherein:
at least one of the at least one user device is further configured to provide unlock data, via the receiver, to satisfy the unlock criteria of the electronic lock.

19. The delivery system of claim 16, further comprising:
a timer for measuring time, wherein the control circuitry is further configured to control the timer to measure a time between removal and replacement of an item from the delivery container.

20. A delivery method comprising:
providing first lock data to a reusable delivery container, the reusable delivery container according to claim 1;
updating unlock criteria for an electronic lock of the delivery container based on the first lock data;
providing delivery data to the delivery container, the delivery data corresponding to a first delivery location for the delivery container;
updating a location of the delivery container to the first delivery location;
providing second lock data to the delivery container, the second lock data being different to the first lock data;
updating the unlock criteria based on the second lock data;
updating the delivery data so as to display updated delivery information on the display of the delivery container, the delivery data corresponding to a second delivery location; and
updating a location of the delivery container to the second delivery location.
